(19) United States
(12) Patent Application Publication
(10) Pub. No.: US 2017/0170532 A1
(43) Pub. Date: Jun. 15, 2017

(54) METHOD FOR RECYCLING VALUABLE METALS FROM SPENT BATTERIES

(71) Applicant: INSTITUT NATIONAL DE LA RECHERCHE SCIENTIFIQUE, Quebec (CA)

(72) Inventors: Jean-Francois Blais, Beauport (CA); Guy Mercier, Quebec (CA); Kulchaya TANONG, Nakhonsrithammarat (TH); Lan Huong Tran, Quebec (CA); Lucie Coudert, L'Isle d'Espagnac (FR)

(21) Appl. No.: 15/377,570

(22) Filed: Dec. 13, 2016

(30) Foreign Application Priority Data
Dec. 15, 2015 (CA) 2.915.371

(51) Int. Cl. H01M 10/54; C25C 7/06; C22B 7/00; C22B 3/00; C22B 19/30; C22B 47/00; C25C 1/16; H01M 6/52

(52) U.S. Cl. CPC H01M 10/54; C25C 1/16; C25C 7/06; H01M 6/52; C22B 23/0438; C22B 23/043; C22B 23/0423; C22B 23/0469; C22B 19/30; C22B 19/22; C22B 19/26; C22B 17/04; C22B 47/00; C22B 7/007

(57) ABSTRACT

A process has been developed in order to recover and recycle the metals present in spent batteries, including alkaline spent batteries alone or mixed with other types of spent batteries. This method shows a good potential in terms of metals recoveries efficiencies and economic feasibility. Firstly, the spent batteries are crushed (optionally after having been frozen in the case of spent batteries of mixed types). Then, the undesirable parts (plastics, steel cases, papers, etc.) are removed by screening. The collected powder, containing the metals, is mixed with a solution of sulfuric acid in the presence of a reducing agent. The solid/liquid separation is carried out by filtration and the leachate is purified in order to selectively recover the metals. The purification steps consist of: a) recovering Zn by solvent extraction followed by an electrowinning process; b) simultaneously recovering Mn and Cd by solvent extraction process; c) selectively recovering Cd from the mixture solution of Cd and Mn by electrowinning process; d) precipitating Mn from a pure solution of MnSO₄ in a carbonate form; e) removing the impurities present in the effluent by solvent extraction in order to obtain a pure NiSO₄ solution; f) precipitating Ni from a NiSO₄ solution in a carbonate form.

### RELATED APPLICATIONS

The present application claims the priority benefit of Canadian Patent Application No. 2.915.371 filed Dec. 15, 2015, incorporated by reference in its entirety herein.

### FIELD OF THE INVENTION

The present invention relates to a method that allows the removal of metals from spent batteries by acidic dissolution and recovery of the valuable metals from the leachates using solvent extraction, electrowinning and selective precipitation. Particularly, this recycling process also allows one to treat a mixture of different types of spent batteries without any expensive sorting step depending on the type of battery.

### BACKGROUND

Batteries are used as a source of energy in electronic equipment. Nowadays, we cannot imagine our life without the use of batteries. Alkaline and zinc-carbon cells are the most commonly used household batteries in Canada (RIS international Ltd., 2007). These types of batteries are non-rechargeable which means that they are used only once and then should be discarded when they are discharged. The most commercialized secondary cells are Ni—Cd accumulator followed by SSLA (small sealed lead acid) battery, Ni—MH and Li-ion batteries, respectively (RIS international Ltd., 2007). The rechargeable accumulators provide high-energy intensity and can be reused several times.

In Canada, policies for recycling spent batteries vary from one province to another. In the province of Quebec, all types of household's batteries can be collected and recycled following the strategies developed by the Call2Recycle program. The ministry of environment of the province of Quebec has restricted the landfilling of a huge quantity of end-of-life batteries in Quebec with the help of the Call2Recycle program. Quebec's residents are now familiar with this program and more than 500 000 kg of rechargeable batteries has been collected since 1997 (Call2Recycle, 2012).

Over the last years, many technologies have been developed and some of them, now commercialized, allow the treatment of different types of batteries. The examples of the processes available at industrial scale are: ACCUREC® process (vacuum thermal recycling process), AED process (only applicable for rechargeable Li-batteries), INMETCO process (High Temperature Metal Recovery process), RECYTEC process (pyrometallurgical process), SNAM-SAVAM process (pyrometallurgical process only applicable on batteries containing Cd), etc. Several patents have been found but all of them are different from the present technology in at least one aspect.

U.S. Pat. No. 8,728,419 B1 describes a process developed for the recycling of alkaline spent batteries. These batteries are mainly made of steel case batteries, alkaline electrolytes, a mix of manganese oxide, zinc hydroxide, zinc oxide and some carbon. In this process, only a small part of the manganese is soluble while almost all the zinc is soluble in a solution of sulfuric acid at 60° C. to 80° C. The resulting slurry is then filtered and a cake containing MnO₂ is obtained as well as a leachate containing Mn, Zn and Fe. Iron is removed from the leachate by heating and air oxidation at pH 4. The soluble MnSO₄ is removed as insoluble MnO₂ by adding sodium persulfate at pH 4. The pure solution of ZnSO₄ is then treated by precipitation at pH 10-11 with Na₂CO₃ and ZnCO₃ is then obtained as a final product. The insoluble manganese contained in the cake is then mixed with H₂SO₄ and sodium metabisulfite or sulfur dioxide to dissolve Mn(IV) at 60° C. The pH of this solution is then adjusted to 4 and sodium persulfate is added to form a precipitate of gamma manganese dioxide.

U.S. Pat. No. 5,575,907 describes a process used for the recycling of metals from unsorted spent batteries. The main metals present in the mixture are Mn, Zn, Ni, Cd, Pb and Hg. Firstly, the spent batteries are simply treated by mechanical method to separate the waste into two fractions: coarse and fine fraction. A wet chemical process is used to recover each metal separately. The fine fraction is almost completely leached during the two leaching steps carried out in the presence of water (first leaching step) and in the presence of diluted sulfuric acid and sulfur dioxide (second leaching step). Then, two cationic exchange resins are used to remove Hg and to recover Cu from the acidic leachate. Thirdly, Zn is extracted by a liquid-liquid extraction step using an organic extraction agent. Fourthly, the solution which is free of Cu, Hg and Zn is further sent to a multistage ion exchange step for separating Ni and Cd. Finally, the solution free of Hg, Cu, Zn, Cd and Ni is electrolysed in order to recover solid MnO₂ by pH adjustment. The Cu, Cd, Zn and Ni are also recovered by electrowinning methods in order to obtain the final products in metallic forms.

E.P. No. 0,620,607 B1 describes a process developed to recover metals from a mixture of spent batteries. The mixture may contain Zn, Mn, Ni, Cu and Cd in various concentrations. This recycling method focuses on the recovery of Zn and Mn due to their high consumption in the market. The spent batteries are crushed under a cold dry air stream and the ferrous materials are removed from the non-ferrous metals (Hg, Mn, Zn, Cd and Ni) using a magnetic separation step. The inert materials are then separated from the mineral sludge by flotation. The mineral sludge is then treated by leaching using H₂SO₄ in the presence of a reducing agent at a temperature fixed between 40 and 90° C. Then, Cu is recovered from the leachate by cementation. The Ni and Cd are selectively electrodeposited at pH 4.0-5.5 using a potential between 1.5 and 5.0 V. The Zn and Mn are then simultaneously recovered using an electrowinning process.

From all of these descriptions, it is clear that the existing technologies for treating the mixture of spent batteries developed since 1990-2000 are applied to treat the batteries containing mercury. However, in 2015, mercury has been eliminated from the production of batteries.

Furthermore, some types of batteries have been introduced into the market to replace mercury-containing batteries. There is therefore a need to develop a new process that can be adapted to the new compositions of spent batteries that is efficient, eco-friendly and economically viable. The originality of the present recycling process comes from various aspects. Up to now, no efficient and economically viable technology is able to recover Zn, Mn, Cd and Ni from a mixture of spent batteries including alkaline, Zn-Carbon, Ni—Cd, Ni—MH, Li-ion and Li—M batteries without any expensive sorting step.

### SUMMARY OF THE INVENTION

An aspect of the present invention is to provide a new method to recover the valuable metals from spent batteries without any expensive sorting step. A further aspect is to develop a simple and cheap process for treating mixtures of different types of spent batteries, allowing an industrial application of the process. A further aspect is to eliminate heavy metals from the waste streams and eliminate the need to landfill spent batteries.

In a particular aspect, there is provided a process for recovering valuable metals from spent batteries comprising the steps of: a) crushing the spent batteries; b) separating debris as a coarse fraction and a fine fraction; c) leaching metals present in the fine fraction with strong inorganic acid and a reducing agent to produce an aqueous leachate; d) extracting Zn from the leachate by electrowinning to obtain a metallic deposit of Zn and a Zn-depleted aqueous solution; e) extracting Mn from the Zn-depleted aqueous solution of step d) by precipitation at pH of about 8-9 to obtain precipitated Mn, and a Zn- and Mn-depleted aqueous solution.

In a particular aspect, there is provided the process as defined above, further comprising the step of: d-i) eliminating residual Zn by precipitation as ZnS using NaOH and Na₂S to obtain a rich MnSO₄ solution.

In a particular aspect, there is provided the process as defined above, further comprising the step of: d-ii) extracting Zn from the leachate by aqueous solvent extraction.

In a further aspect, there is provided the process as defined above, further comprising the step of: d-iii) extracting Cd and Mn from the Zn-depleted aqueous solution of step d) by organic solvent extraction, electrodeposition of Cd and precipitation of Mn to obtain a Zn-, Cd- and Mn-depleted solution.

In a further aspect, there is provided the process as defined above, further comprising the steps of: f) eliminating impurities from the Zn-, Cd- and Mn-depleted aqueous solution at pH about 5-6 to obtain a purified solution of NiSO₄; and g) precipitating Ni from the NiSO₄ solution.

In a particular aspect, there is provided a process for recovering metals from alkaline spent batteries, comprising the steps of: a) crushing the alkaline spent batteries to obtain a coarse fraction and a fine fraction rich in Zn and Mn; b) carrying out leaching on the fine particles in presence of sulfuric acid and a reducing agent to reduce Mn(IV) to Mn(II); c) selectively recovering Zn by electrowinning; d) eliminating residual Zn by precipitation as ZnS using NaOH and Na₂S to obtain a rich MnSO₄ solution; and e) precipitating the Mn in carbonate form from the MnSO₄-rich solution.

In an alternative aspect, there is provided a process for recovering valuable metals from a mixture of spent batteries, comprising the steps of: a) crushing the spent batteries at a temperature at least as low as −20° C.; b) separating debris as a coarse fraction and a fine fraction by passing the debris through a screen or a sieve; c) leaching metals present in the fine fraction with a strong inorganic acid and a reducing agent to produce an aqueous leachate; d) extracting Zn from the leachate by solvent extraction and electrodeposition to obtain a metallic deposit of Zn and a Zn-depleted aqueous solution; e) extracting Cd from the Zn-depleted aqueous solution by solvent extraction and electrodeposition; f) extracting Mn from the Zn-depleted aqueous solution of step d) by organic solvent extraction and precipitation to obtain a Zn-, Cd- and Mn-depleted aqueous solution; g) eliminating impurities from the Zn-, Cd- and Mn-depleted aqueous solution by organic solvent extraction to obtain a purified solution of NiSO₄; and h) precipitating Ni from the NiSO₄ solution.

Other aspects and features of the present invention will become more apparent upon reading of the following non-restrictive description of preferred embodiments thereof, given by way of example only, with reference to the accompanying drawings.

The contents of the documents cited in the present disclosure are incorporated by reference thereto.

### DETAILED DESCRIPTION

This invention will be described hereinbelow, referring to particular embodiments and the appended figures, the purpose thereof being to illustrate this invention rather than to limit its scope.

### BRIEF DESCRIPTION OF THE FIGURES

FIG. 1 shows a simplified schematic flow diagram of the mechanical pre-treatment of a mixture of spent batteries developed to obtain the fine powder that contains the valuable metals.

FIG. 2 shows the composition of elements in a mixture of spent batteries.

FIG. 3 illustrates a simplified schematic flow diagram of a recycling process of valuable metals (Zn, Mn, Cd and Ni) from a mixture of spent batteries.

FIG. 4 illustrates a simplified schematic flow diagram of the leaching process used for the simultaneous solubilisation of valuable metals (Zn, Mn, Cd and Ni) from a mixture of spent batteries.

FIGS. 5-7 show a detailed flow diagram of the hydrometallurgical steps used for the recovery of each valuable metal according to FIG. 3.

FIG. 5 shows the zinc recuperation process from the leachate.

FIG. 6 shows the cadmium recuperation process from Zn-free aqueous solution.

FIG. 7 shows the manganese recovery process from a mixture of battery waste.

FIG. 8 illustrates a schematic diagram of the simplified metal recovery process applied to alkaline spent batteries.

### ABBREVIATIONS AND DEFINITIONS

### Abbreviations

As used herein, the abbreviation “S/L ratio” means solid/liquid ratio.

As used herein, the abbreviation “O/A ratio” means organic to aqueous ratio.

### Definitions

The terms “about” and “around” as used herein refer to a margin of +or −10% of the number indicated. For the sake of precision, the terms “about” or “around” when used in conjunction with, for example: 90% means 90% +/−9% i.e. from 81% to 99%. More precisely, the terms “about” or “around”, when used in connection a pH unit, means +or −0.5 unit.

As used herein the singular forms “a”, “and”, and “the” include plural referents unless the context clearly dictates otherwise. Thus, for example, reference to “a cell” includes a plurality of such cells and reference to “the culture” includes reference to one or more cultures and equivalents thereof known to those skilled in the art, and so forth. All technical and scientific terms used herein have the same meaning as commonly understood to one of ordinary skill in the art to which this invention belongs unless clearly indicated otherwise.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

The term “scrubbing” means a purification step of the organic phase in which the undesired elements are removed.

The term “stripping” means a step transferring a metal of interest from the organic phase to the aqueous phase by addition of a diluted or concentrated acid or basic solution.

The term “purified” is used herein to indicate that the compound is enriched, and the absolute level of enrichment or purity is not critical. Those skilled in the art can readily determine appropriate levels of purity according to the use to the original concentration of the compound in the crude material prior to the process.

### DETAILED DESCRIPTION OF PARTICULAR EMBODIMENTS

### Alkaline or Mixed Spent Batteries

In accordance with a particular aspect, there is provided a process for recovering valuable metals from spent batteries comprising the steps of: crushing the spent batteries; separating debris as a coarse fraction and a fine fraction; leaching metals present in the fine fraction with strong inorganic acid and a reducing agent to produce an aqueous leachate; extracting Zn from the leachate by electrowinning to obtain a metallic deposit of Zn and a Zn-depleted aqueous solution; extracting Mn from the Zn-depleted aqueous solution of d) by precipitation at pH of about 8-9 to obtain precipitated Mn and a Zn- and Mn-depleted aqueous solution.

Particularly, the separating step b), is carried out by passing debris through a screen or a sieve. More particularly, the leaching step c) is carried out at ambient temperature. Most particularly, the strong inorganic acid, in the leaching step c), is chosen from: sulfuric acid (H₂SO₄), hydrochloric acid (HCl) and nitric acid (HNO₃); and, in particular the strong inorganic acid is chosen from: a used acid or a recycled acid.

In accordance with a particular aspect, the reducing agent in step c) is sodium meta bisulfite or gaseous SO₂, which reduces Mn(IV) to Mn(II).

In accordance with a particular aspect, the electrowinning in step d) is carried out at about pH 2 with any suitable electrode known in the art, and more particularly with a stainless steel cathode and a Ti/IrO₂ anode. In particular, the extraction of Zn in step d) is kept at a temperature of about 20° C. to about 60° C., more particularly at about 50° C. for mixed batteries and about 20° C. for alkaline batteries.

In accordance with a particular aspect, the process as defined hereinabove further comprises step of: d-i) eliminating residual Zn by precipitation as ZnS using NaOH and Na₂S to obtain a rich MnSO₄ solution. Particularly, the elimination of residual Zn is carried out by selective precipitation at pH of about 4.5. More particularly, the elimination of impurities remaining following step d-i), is carried out by using an organic phase composed of CYANEX® 272 at pH of about 2.5. More particularly, step d-i) is carried out at a temperature of about 40 to about 60° C.

In accordance with a particular aspect, the recovery of Mn as MnCO₃ in step e) is carried out at pH of about 8 to about 9.

In accordance with a particular aspect of the process as defined hereinabove, the spent batteries are alkaline batteries or a mixture of different types of spent batteries.

### Mixed Spent Batteries

In accordance with a particular aspect, the spent batteries belong to a mixture of different types of spent batteries, particularly selected from: alkaline (Zn/MnO₂); Zn-carbon; Ni—Cd; Ni—MH; Li ion; Li M; and mixtures thereof.

In accordance with a particular embodiment of the process when the spent batteries are of mixed types, the crushing step a) is carried out at low temperature, particularly at least under −20° C. More particularly, the low temperature is achieved by freezing the spent batteries using liquid nitrogen before the crushing step a).

In accordance with a particular embodiment of the process when the spent batteries are of mixed types, the extraction of Zn in step d) is carried out at a temperature of about 50° C. for mixed batteries. In accordance with a particular embodiment of the process when the spent batteries are of mixed types further comprises step d-ii) of extracting Zn from the leachate by aqueous solvent extraction. Particularly, the extraction of Zn in step d-ii) is carried out using an organic phase comprising CYANEX® 272 at pH of about 2.5 and more particularly at a temperature of about 40° C. to about 60° C. More particularly, the Zn is stripped from the organic phase by the addition of H₂SO₄ at a ratio organic:aqueous phases (O:A) of about 2:1 (v/v).

In accordance with a particular embodiment of the process when the spent batteries are of mixed types, step e) further comprises extracting Mn from the Zn-depleted aqueous solution of step d) by aqueous solvent extraction. Particularly, the extraction of Mn in step e) is carried using Na₂CO₃ as the neutralizing agent at pH of about 8-9.

Particularly, the process further comprises a step of: d-iii) extracting Cd from the Zn-depleted aqueous solution of d) by organic solvent extraction and electrodeposition to obtain a Zn-, and Cd- and Mn-depleted solution. Particularly, the extractions of Cd and Mn in steps d-iii) and e) are carried out simultaneously using an organic phase composed of DEHPA® at pH of about 2.5. More particularly, the Cd- and/or Mn-rich organic phase is scrubbed at a ratio organic:aqueous phases (O:A) of about 20:1 (v/v) at a pH of about 2.3. Still, more particularly, the Cd and/or Mn is stripped from the scrubbed organic phase by the addition of H₂SO₄ at a ratio O:A of 4:1 (v/v). Most particularly, the extraction of Cd in step d-iii or step e) is carried out at a temperature of about 40 to 60° C., even most particularly, at about 50° C.

In accordance with a particular embodiment of the process when the spent batteries are of mixed types, the extraction of Cd in step d-iii) is carried out by electrowinning at pH of about 2.

In accordance with a particular embodiment of the process when the spent batteries are of mixed types, further comprises steps: f) eliminating impurities from the Zn-, Cd- and Mn-depleted aqueous solution at pH about 5-6 to obtain a purified solution of NiSO₄; and g) precipitating Ni from the NiSO₄ solution. Particularly, the Ni precipitation in step g) is carried using Na₂CO₃ as a neutralizing agent at pH of about 7-10.

### Alkaline Spent Batteries

In accordance with an alternative embodiment, there is provided a method for recovering metals from alkaline spent batteries comprising the steps of: a) crushing to obtain a coarse fraction and a fine fraction rich in Zn and Mn; b) carrying out leaching on the fine particles in presence of sulfuric acid and a reducing agent to reduce Mn(IV) to Mn(II); c) selectively recovering Zn by electrowinning; d) eliminating residual Zn by precipitation as ZnS using NaOH and Na₂S to obtain a rich MnSO₄ solution; and e) precipitating the Mn in carbonate form from the MnSO₄-rich solution.

In accordance with a particular embodiment of the process when the spent batteries are alkaline, the electrowinning in step c) is carried out at pH of about 2, with any suitable electrode known in the art, more particularly with a stainless-steel cathode and a Ti/IrO₂ anode. In accordance with a particular embodiment of the process when the spent batteries are alkaline batteries, the extraction of Zn in step d) is carried out at a temperature of about 20° C. More particularly, the elimination of the residual Zn as ZnS in step d) is carried at pH of about 4.5. Still, more particularly, the recovery of Mn as MnCO₃ in step e) is carried out at pH of about 8-9.

### Figures Explanations

The present invention concerns a chemical process used for the recovery of metals (Zn, Mn, Cd and Ni) from unsorted spent batteries. The different types of residual batteries such as alkaline, Zn—C, Ni—Cd, Ni—MH, Li-ion and Li—M batteries may be mixed together according to the proportion of each type of batteries collected for the recycling. The main metals composition comprises Zn, Mn, Ni, Cd and Co, etc. The present method can reduce the costs of the process because it does not require expensive sorting steps, and also reduces the disposal of toxic metals in landfill sites.

In a particular aspect, the fine particles are removed from the spent batteries by mechanical treatment (FIG. 1.) under an inert atmosphere. First, liquid nitrogen is used to cool down the battery cast at a temperature estimated to be around −80° C. This method allows a secure crushing step of spent batteries even if they are not fully discharged. By cooling down the spent batteries, the risks of violent reactions are diminished or avoided, especially when isolating the metallic powder of the Li—M and Ni—MH batteries. The mechanical treatment also includes a screening step used to remove the coarse particles. These undesirable coarse particles (iron scraps, paper and plastic) present in the sample are removed by screening the fine particles through two different sieves (about 1 mm and about 2 mm sieves). The mixture of fine particles is then dried at about 60° C. and grinded to a powder. As a result, the average fine particles size of the resulting powder is estimated at around 200 μm to 250 μm, particularly about 214 μm.

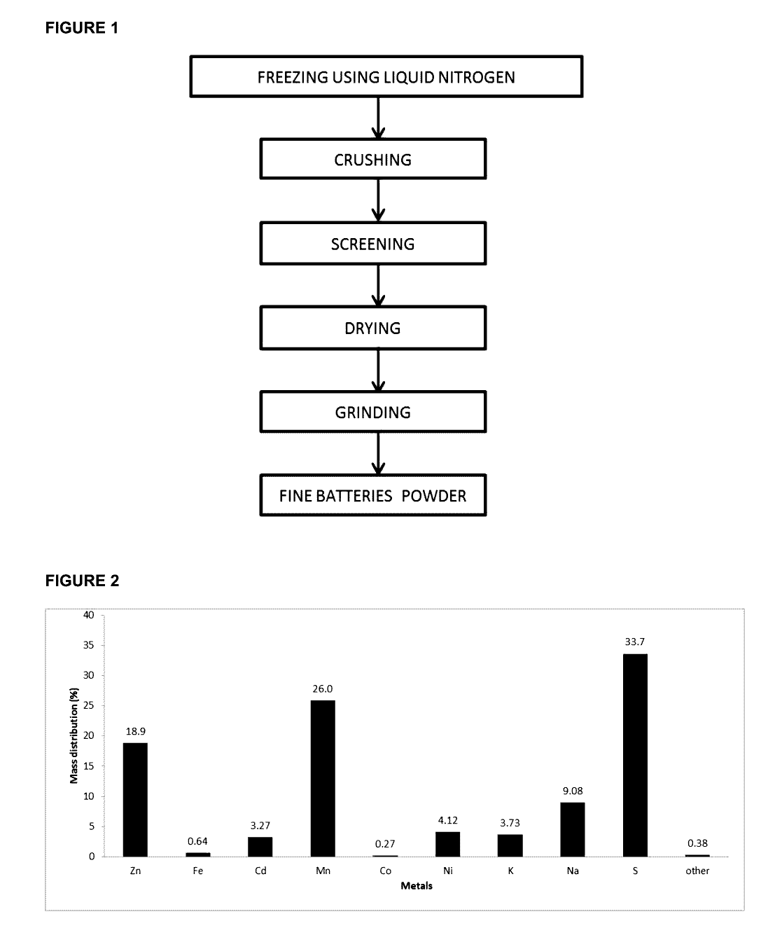

According to an aspect of the present invention, the fine particles (powder) are then submitted to a chemical leaching step. These fine particles are mixed with a solution of inorganic acid (H₂SO₄) which is a very effective oxidizing agent that can release two protons. A stoichiometry value of sodium metabisulfite (a reducing agent) is added to the leaching solution to improve the dissolution of MnO₂. After the dissolution step, the solid phase is separated from the liquid phase by filtration. As shown in FIG. 2, analysis of the elements present in the effluent emerging from the leaching process is conducted by ICP-AES. This effluent contains 33.7% of S (37.1 g), 26.0% of Mn (28.6 g), 18.9% of Zn (20.8 g), 3.27% of Cd (3.60 g), 9.08% of Na (10.0 g), 4.12% of Ni (4.50 g), 0.64% of Fe (0.70 g), 0.27% of Co (0.30 g) and 0.38% of the others.

According to another aspect of the invention several solvent extraction, electrowinning and precipitation steps have been developed to selectively recover the valuable metals (Zn, Mn, Cd and Ni).

The separation method comprises the steps of:
a) Adjusting the pH of a leaching solution. A solvent extraction is then applied to transfer

Zn from the leachate to an organic phase. Then, Zn is stripped by a diluted H₂SO₄ solution. Finally, Zn is electrodeposited in a metallic form with a purity of 99%.
b) Simultaneously recovering Mn and Cd by solvent extraction at pH about 2.5. The Cd and Mn present in the organic phase are then stripped by a diluted H₂SO₄ solution in order to obtain a solution rich in Mn²⁺ and Cd²⁺ in acidic sulfate solution.
c) Selectively electrodepositing Cd from the acidic sulfate solution containing Cd²⁺ and Mn²⁺. Finally, the Cd²⁺ is recovered by electrodeposition in a metallic form with a purity of 97% while Mn still remains in the sulfate solution.
d) Precipitating Mn from the acidic sulfate solution containing Mn from step b) with Na₂CO₃ at pH 8-9. MnCO₃ is obtained as a final product with a purity of 94-97%.
e) Simultaneously removing the impurities such as Co, Cd and Zn from the Zn-, Mn- and Cd-depleted leachate by solvent extraction at pH about 5.5 and leaving the Ni in the sulfate solution (Zn-, Mn-, Cd-depleted leachate).
f) Precipitating Ni from NiSO₄ solution from step e) with Na₂CO₃ at pH 7-10. A final product of NiCO₃ is obtained, particularly with a purity of about 95-97%.

FIG. 1 illustrates the mechanical treatment steps in a particular embodiment of the present invention. The mechanical treatment process includes: 1) a freezing step of the spent batteries using liquid nitrogen; 2) a crushing step of the spent batteries; 3) a screening step using two sieves (1 mm and 2 mm sieves) in order to remove the coarse particles; 4) a drying step at 60° C.; 5) a grinding step to reduce the particles' size (i.e. fine particles into a powder).

FIG. 2 reveals the compositions of leachate obtained from the leaching process.

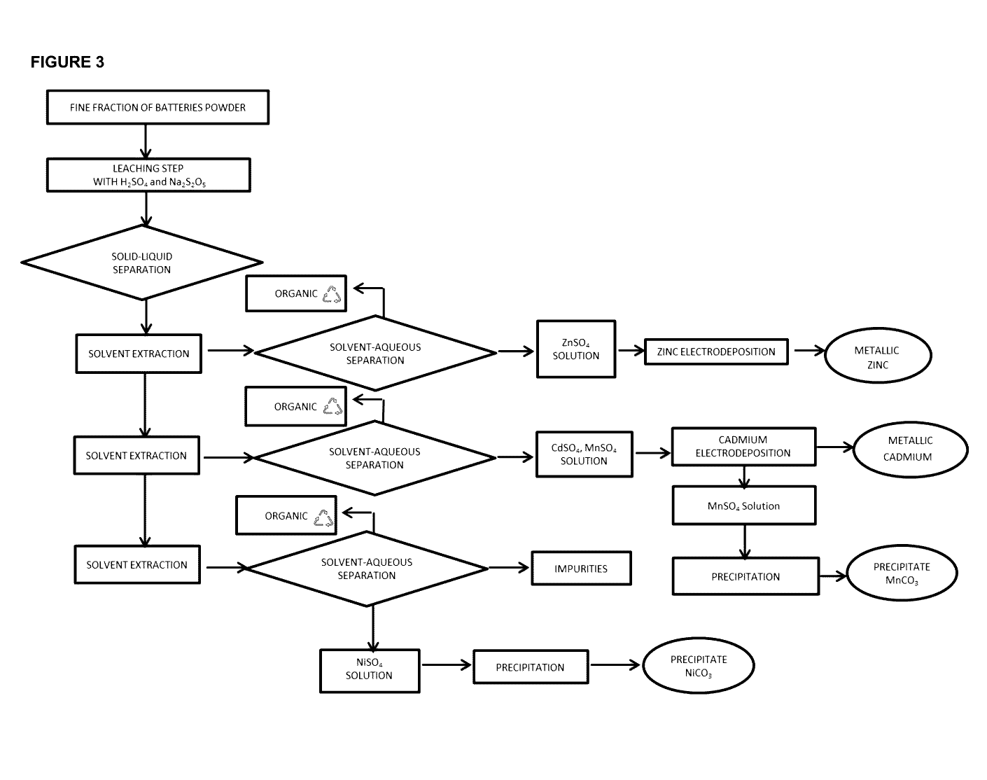

FIG. 3 reveals the total chemical leaching and metals recoveries processes used after the mechanical treatment.

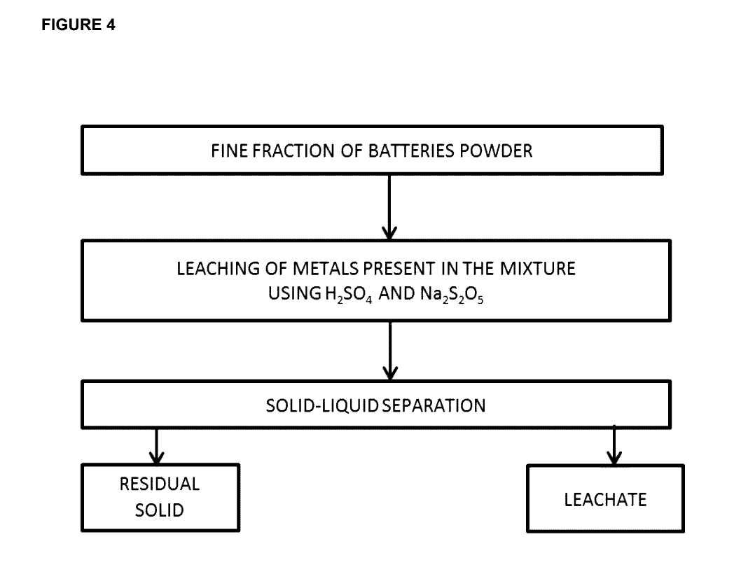

FIG. 4 illustrates the dissolution of the solids and the salts in the presence of sulfuric acid and sodium metabisulfite, introduced as a reducing agent to improve the solubilization of the valuable metals (Zn, Mn, Cd and Ni). The solid is separated from liquid by filtration. The leachate obtained contains the valuable metals such as Mn, Zn, Cd and Ni and other metals such as Co and Fe.

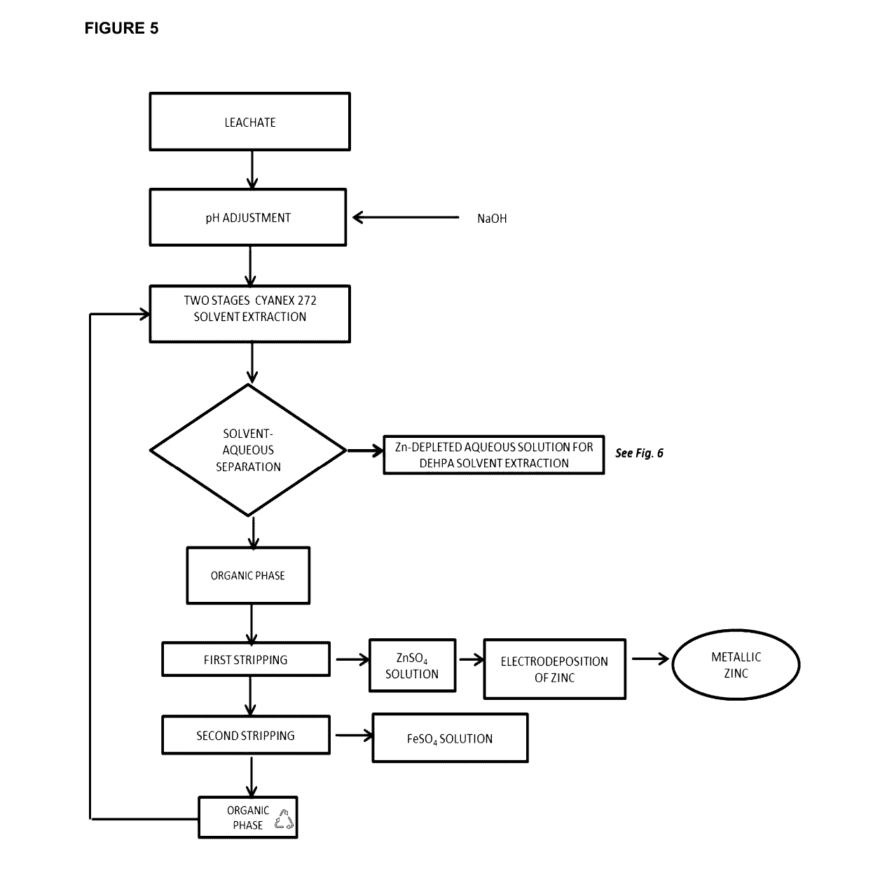

The individual separation steps are described in greater details in the following sections with references to FIGS. 5 to 7.

As FIG. 5 shows that the leaching solution is subjected to a pH adjustment to about 2.5 by the use of a neutralizing agent (i.e. sodium hydroxide), before being sent to the solvent extraction step where Zn is selectively extracted from the solution and transferred to the organic phase.

A solvent extraction step is used to recover selectively Zn by controlling an equilibrium pH. At least one organic extraction steps may be necessary to completely extract Zn from the aqueous solution. During the extraction step, a NaOH solution is added to control the equilibrium pH. The iron is inevitably co-extracted with Zn in the organic phase because it is extracted at a lower equilibrium pH compared to Zn. After solvent-aqueous separation, the organic solvent containing Zn and Fe is subjected to a stripping step by using a solution of H₂SO₄. The first stripping step is conducted to recover almost all Zn from the solvent (organic phase) and the second stripping step, carried out with concentrated acid, is necessary in order to remove the residual Fe from the organic solvent in order to allow the recycling of the solvent in the solvent-aqueous separation process. The loss of solvent is estimated at 50 ppm for each solvent-aqueous separation step. The ZnSO₄ solution obtained from the first stripping process is then treated by electrodeposition in order to recover the Zn under metallic form, particularly with a purity up to 99%.

The aqueous solution which is depleted of zinc is then transferred to the second solvent extraction step in order to simultaneously extract Cd and Mn.

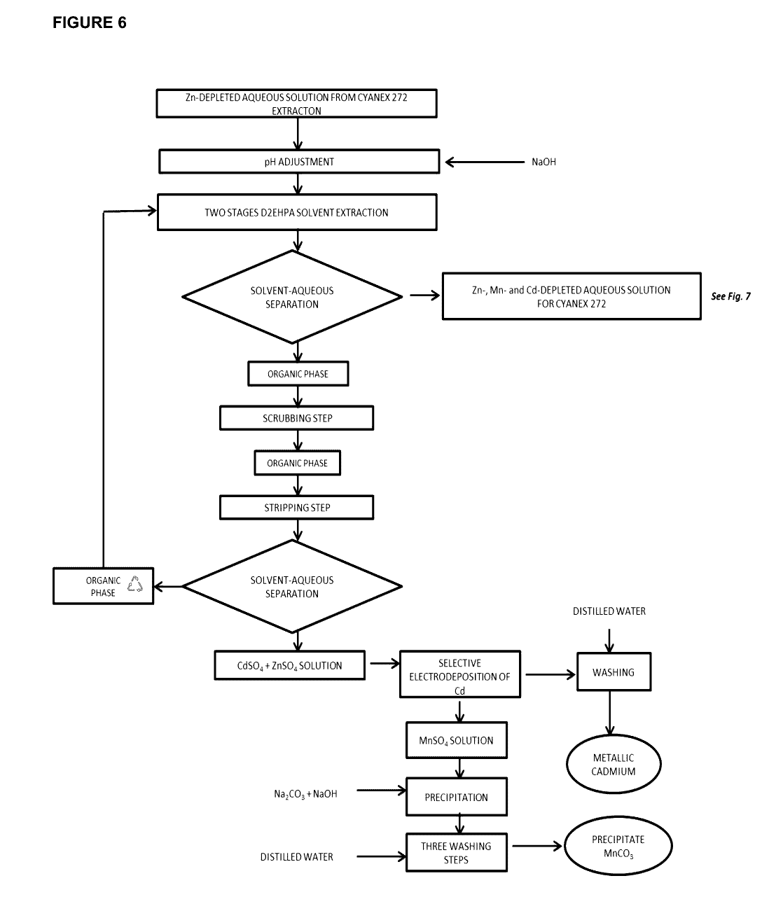

An acidic solvent extraction step is applied to the Zn-depleted aqueous solution in order to simultaneously extract Cd and Mn. As presented in FIG. 6, a solution of NaOH is used to adjust the pH of the Zn-depleted aqueous solution to about 2.5. At least one organic extraction steps may be necessary to completely extract Cd and Mn from the Zn-depleted aqueous solution. The equilibrium pH of 2.5 is controlled by the addition of a solution of NaOH during the extraction step. However, a small amount of Co and Ni are co-extracted even if the pH is carefully controlled. The organic solvent is then separated from the aqueous phase. A scrubbing step may then be performed to remove the impurities of Co and Ni from the organic solution rich in Cd and Mn.

The scrubbing solution is initially prepared by diluting the analytical reagents grade of

MnSO₄ and CdSO₄ with distilled water. Then, small amounts of this scrubbing solution are intensively mixed with the organic solvent during 10 minutes. The impurities including Ni and Co are mostly eliminated from the organic solvent. The organic solvent rich in Cd and Mn is then stripped by the addition of a solution of H₂SO₄ in a single step.

The solution containing CdSO₄ and MnSO₄ is then sent to the electrowinning step. The Cd is selectively recovered by electrowinning in its metallic form while the Mn still remains in solution. The deposit of Cd obtained is then washed with distilled water to remove the soluble Mn.

The Cd-depleted effluent is then sent to the precipitation step. Mn is precipitated in its carbonate form (MnCO₃). Sodium and sulfur are the main impurities present in the precipitate of MnCO₃. After washing the precipitate three times with distilled water (10% solid/liquid ratio), these impurities are almost completely removed.

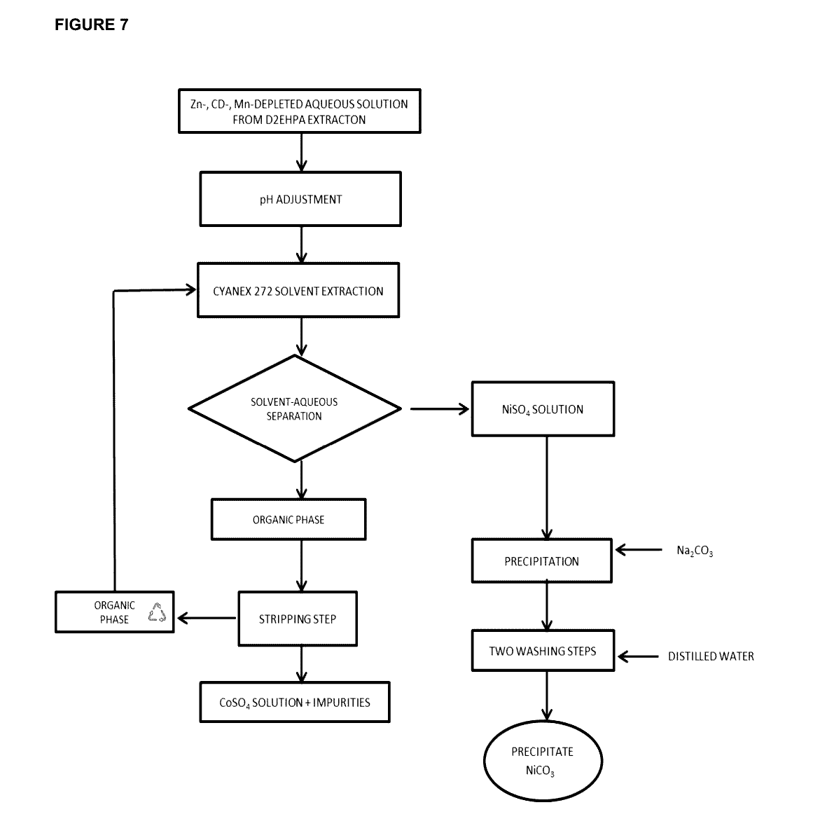

After the two solvent-aqueous extraction steps, the aqueous solution is depleted of Zn, Cd and Mn. This solution (Zn-, Cd- and Mn-depleted aqueous solution) is then transferred to the third solvent extraction step as shown in FIG. 7. The Zn-, Cd- and Mn-depleted aqueous solution mainly contains Ni and some impurities (Co, Zn and Cd). In order to remove these impurities, the pH of the solution is adjusted to about 5.5. The impurities are selectively extracted from the Zn-, Cd- and Mn-depleted aqueous solution and transferred to the organic solvent at pH about 5.5 in a single extraction step. The impurities present in the organic phase are then stripped by the addition of sulfuric acid and recycled back to the extraction stage. The organic solvent can then be recycled into the solvent-aqueous extraction step.

The aqueous solution depleted of the impurities mainly contains Ni. The Ni is then recovered as NiCO₃ by precipitation with Na₂CO₃. The sodium and sulfur are the main impurities present in the NiCO₃ precipitate as well as for the precipitate of MnCO₃. Two washing steps using distilled water with a solid/liquid ratio of 10% (w/w) are sufficient to obtain a precipitate of NiCO₃ in high purity (about 95-97% purity).

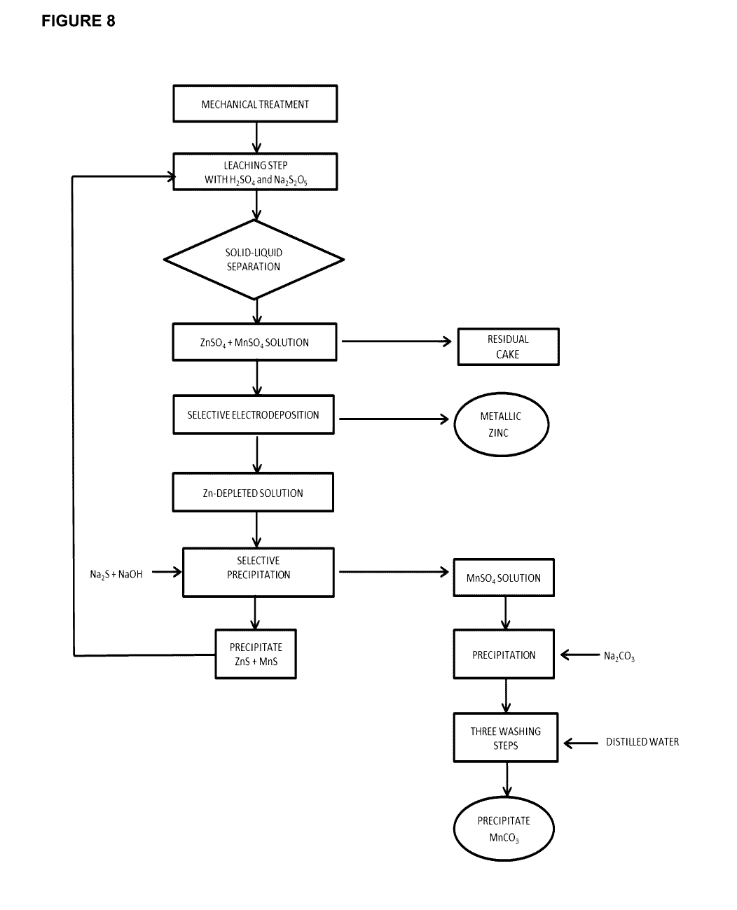

FIG. 8 illustrates the particular process developed for the recycling of Zn and Mn from alkaline spent batteries. The alkaline spent batteries are firstly crushed and screened in order to remove the coarse particles. The fine particles are further grinded in order to homogenize the sample and to reduce the particles size, particularly into a powder. These fine particles contain zinc oxide, unreacted metallic zinc, manganese oxide and carbon powder. The metals present in the fine particles are then leached in sulfuric acid in the presence of a reducing agent to improve the dissolution of Mn(IV). The solid (residual cake) is then separated by filtration. Then, Zn is selectively recovered from the aqueous solution containing Mn and Zn at pH 2 by electrowinning. A deposit of metallic zinc with a high purity is obtained after this step. The pH of the leaching solution obtained after electrowinning step is then adjusted by the addition of a solution of NaOH at pH 4.5 following by the addition of Na₂S to precipitate the residual zinc present in the aqueous solution. During this precipitation step, a small amount of Mn co-precipitate with Zn. This ZnS precipitate that contains some Mn impurities can be recycled back to the leaching step.

The Zn-depleted aqueous solution (MnSO₄ solution) is then transferred to a second precipitation step. The pH of the Zn-depleted aqueous solution is adjusted to about 7 by the addition of a solution of NaOH followed by Na₂CO₃ in order to precipitate the Mn. Almost all Mn is precipitated at pH between 8 and 9 in the carbonate form. A precipitate of MnCO₃ with a high purity (about 98%) is obtained after this step. The inorganic components in this particular embodiment have been analyzed by inductive coupled plasma atomic emission spectroscopy (ICP-AES).

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is average molecular weight, temperature is in degrees Centigrade, and pressure is at or near atmospheric.

### EXAMPLES

### Example 1

### Recovery of Metals from a Mixture of Spent Batteries

### Recovery of Zinc

Refer to FIG. 1, the collected spent batteries were frozen using nitrogen liquid and were then crushed in order to remove steel castings. The fine particles were screened through a 1-2 mm aperture sieves, dried at 60° C. and then grinded. The fine particles obtained huge amounts of Zn, Mn, Cd and Ni. The leaching step was carried out by mixing 109 g of the fine particles with 49 g of sodium metabisulfite and 1 L of a solution of H₂SO₄ (1.34 M) as shown in FIG. 4. The leaching process was conducted during 45 minutes at ambient temperature. The solid cake was then separated from the liquid by filtration. According to our experiments, 1 L of the leaching solution was composed of Mn (28.6 g), Zn (20.8 g), Cd (3.6 g), Ni (4.5 g), Fe (0.7 g) and Co (0.3 g) and the pH of the solution was equal to 1.

From FIG. 5, the pH of the leachate was then adjusted at 2.5 by the addition of a solution of NaOH (10 M), which was suitable for the selective extraction of Zn from the leachate by an organic solvent. The organic solvent consisted of 30 vol. % of CYAN EX® 272, 2 vol. % of

TBP (tri-butyl phosphate) and 68 vol. % of kerosene. Two stages of organic solvent extraction with an O/A ratio of 2/1 (v/v) were required to completely extract the Zn from the aqueous solution. The temperature of the extraction step was kept at 50° C. After organic and aqueous phase separation, the residual metals present in the aqueous phase were analyzed by ICP-AES. The mass balance was used to calculate the amount of Zn present in the organic phase, which was equal to 20.7 g. Iron was co-extracted with zinc into the organic phase. The Zn was selectively stripped from the organic phase by the addition of a solution of H₂SO₄ (0.4 M) at an O/A ratio of 2/1 (v/v). Most of the zinc present in the organic phase was stripped in a single step. The residual Fe present in the organic phase was then stripped by the addition of a more concentrated solution of H₂SO₄ (1 M) with an O/A ratio of 2/1 (v/v). The stripped solution obtained from the second stripping step was recycled to the next cycle. The extraction and the stripping retention times were fixed to 10 minutes for all the steps.

The stripping effluent obtained from the first stripping step contained 9.6 g/L of ZnSO₄. This solution was then sent to an electrowinning compartment. The zinc was then electrodeposited at pH 2 by using stainless steel as cathode and Ti/IrO₂ as anode. After two hours of electrowinning at a current density fixed at 360 A/m², 86% of the Zn was deposited on the cathode. Approximately 16.4 g of a metallic deposit of Zn (99% purity) was obtained as a final product. The amount of the impurities such as Cd or Fe which could be present in the metallic deposit of zinc was measured. To obtain these values, the deposited cathode was washed in 5% HNO₃ then the metals compositions in this aqueous solution were measured by ICP-AES.

### Recovery of Cadmium

The Zn-depleted aqueous solution from [0075] mainly contained metals such as Mn (27.7 g), Cd (3.5 g), Ni (4.4 g), Zn (0.1 g) and Co (0.3 g). In accordance with FIG. 6, the pH of this solution was adjusted to 2.9 before being mixed with the organic solvent. The organic solvent consisted of 30 vol. % of D2EHPA®; 5 vol. % of TBP and 65 vol. % of kerosene. Two extraction steps were required to completely extract Cd from the solution and the O/A ratio was fixed at 2/1 (v/v). The temperature was maintained at 50° C. for all of the experiments and the equilibrium pH of 2.2 was obtained by the addition of a solution of NaOH. Cd and Mn were co-extracted and transferred to the organic phase. Using mass balance calculation, approximately 25.8 g of Mn, 2.7 g of Cd, 0.9 g of Ni, 0.1 g of Zn and 0.1 g of Co were transferred to the organic phase. After the separation of the organic phase from the aqueous phase, a scrubbing method was used to eliminate the main impurities such as Ni and Co from the organic phase. The scrubbing solution which was concentrated in Mn and Cd allowed the removal of Co and Ni from the organic phase by replacing the impurities molecules present in organic phase by Mn and Cd with pH control. The initial scrubbing solution contained 32 g/L of Mn and 7.4 g/L of Cd. The scrubbing O/A ratio was equal to 20/1 (v/v) and its initial pH was fixed at 2.3. The organic solvent collected after the scrubbing step mainly contained Mn and Cd. Approximately 200 mL of scrubbed solution, collected after the first scrubbing stage, was recycled to the extraction step. The Cd and Mn present in the organic solvent were then stripped by the addition of a solution of H₂SO₄ (1.2 M) with the O/A of 4/1 (v/v). After the stripping step, the aqueous solution collected contained Mn (23.8 g), Cd (2.3 g), Ni (0.02 g), Co (0.01 g) and Zn (0.1 g). The reaction time of the extraction steps including the scrubbing step and the stripping step were fixed at 10 minutes for all the tests. The stripped solution was then transferred to the electrolysis compartments. Here, the Cd was selectively electrodeposited from the aqueous solution while the other metals (Mn and traces of Ni, Co, Zn) still remained in the aqueous solution. Stainless steel and Ti/IrO₂ were used as the cathode and the anode, respectively. The selective electrowinning of Cd was conducted at pH 2 during 240 minutes with a current density fixed at 360 A/m². The Cd recuperation efficiency by electrowinning was equal to 100% with a loss of manganese estimated at 2.9%. The Cd metallic powder obtained was then washed using distilled water with a solid/liquid ratio (S/L ratio) fixed at 10% in order to eliminate the dissolved manganese. The Cd powder obtained was digested by AQUA REGIA® (HNO₃: HCl=3:1) in order to determine the impurities. Finally, 2.36 g of metallic Cd with a purity of 97% was obtained.

### Recovery of Manganese

After the electrowinning of Cd, the pure aqueous solution of MnSO₄ was further transferred to the precipitation step as revealed in FIG. 6. This effluent contained 23.8 g of Mn. The pH of the solution was adjusted to 7 by the addition of a NaOH solution followed by the addition of 53 g of Na₂CO₃. The Mn present in the pure MnSO₄ aqueous solution was almost all (over 90%) precipitated at pH 8-9. Filtration was used to separate MnCO₃ precipitate from the liquid (supernatant). The precipitate of MnCO₃ was washed three times by distilled water with a S/L ratio fixed at 10%. A precipitate of MnCO₃ with a 97% purity (23.8 g as Mn) was obtained as a final product.

### Recovery of Nickel

The Zn-, Cd- and Mn-depleted aqueous solution obtained from the D2EHPA® extraction step contained Mn (1.89 g), Cd (0.79 g), Ni (3.45 g) and Co (0.21 g). This aqueous solution (raffinate) depleted of Zn, Cd and Mn was then transferred to the third solvent extraction step as shown in FIG. 7. The organic solvent consisted of 10 vol. % of CYAN EX® 272, 2 vol. % of TBP and 88 vol. % of kerosene. The pH of the raffinate was initially adjusted to 5.5. The O/A ratio of 0.5/1 (v/v) was applied to selectively extract the impurities (Co, Cd and Mn residues) with an equilibrium pH equal to 5.7 The organic phase was then separated from the aqueous phase. The organic solvent was then stripped with a solution of H₂SO₄ (0.4 M) with O/A ratio of 2/1 (v/v). The temperature and the reaction time were fixed at 50° C. and 10 minutes, respectively.

The washed organic solvents in all solvent extraction steps in this example were reused in the next treatment cycle and the acid solutions emerging from the electrodeposition were returned to the stripping step.

By removing the impurities from the Zn-, Mn- and Cd-depleted aqueous solution using solvent extraction, the aqueous solution rich in Ni (2.4 g as Ni) obtained was transferred to the precipitation compartment. 13 g of Na₂CO₃ were added to precipitate the Ni at pH 7-10. The precipitate of NiCO₃ was then washed two times by distilled water. A S/L ratio fixed at 10% was applied in the washing step and a precipitate of NiCO₃ (2.4 g as Ni) with a purity of 97% was obtained as a final product.

### Example 2

### Recovery of Metals from a Synthetic Solution Representative of a Mixture of Spent Batteries

This example related to the recovery of valuable metals (Cd, Mn and Ni) from a synthetic solution is different from Example 1 where the recovery of cadmium, manganese and nickel was conducted with a real leaching solution emerging from the application of the leaching process to a mixture of spent batteries. The composition of the synthetic solution presented herein was slightly different from those obtained from the leaching of valuable metals from a mixture of spent batteries to simulate the behavior of the recovery process with variation of the initial composition of spent batteries (alkaline, alkaline, Zn-Carbon, Ni—Cd, Ni—MH, Li-ion and Li—M batteries).

### Recovery of Zinc

According to Example 1, 1 L of the leaching solution was composed of Mn (26.1 g), Zn (18.5 g), Cd (3.7 g), Ni (3.2 g), Fe (0.5 g) and Co (0.3 g) and the pH of the solution was equal to 1.

From FIG. 5, the pH of the leachate was then adjusted at 2.5 by the addition of a solution of NaOH (10 M), which was suitable for the selective extraction of Zn from the leachate by an organic solvent. The organic solvent consisted of 20 vol. % of CYAN EX® 272, 2 vol. % of TBP and 78 vol. % of kerosene. Two stages of organic solvent extraction with an O/A ratio of 2/1 (v/v) were required to completely extract the Zn from the aqueous solution. The temperature of the extraction step was kept at 50° C. After organic and aqueous phase separation, the residual metals present in the aqueous phase were analyzed by ICP-AES. The mass balance was used to calculate the amount of Zn present in the organic phase, which was equal to 18.3 g. Iron was co-extracted with zinc into the organic phase. The Zn was selectively stripped from the organic phase by the addition of a solution of H₂SO₄ (0.4 M) at an O/A ratio of 2/1 (v/v). Most of the zinc present in the organic phase was stripped in a single step. The residual Fe present in the organic phase was then stripped by the addition of a more concentrated solution of H₂SO₄ (1 M) with an O/A ratio of 2/1 (v/v). The stripped solution obtained from the second stripping step was recycled to the next cycle. The extraction and the stripping retention times were fixed to 10 minutes for all the steps.

The stripping effluent obtained from the first stripping step contained 9.2 g/L of ZnSO₄.

This solution was then sent to an electrowinning compartment. The zinc was then electrodeposited at pH 2 by using stainless steel as cathode and Ti/IrO₂ as anode. After two hours of electrowinning at a current density fixed at 360 A/m², 92% of the Zn was deposited on the cathode. Approximately 16.8 g of a metallic deposit of Zn (99% purity) was obtained as a final product. The amount of the impurities such as Cd or Fe which could be present in the metallic deposit of zinc was measured. To obtain these values, the deposited cathode was washed in 5% HNO₃ then the metals compositions in this aqueous solution were measured by ICP-AES.

### Recovery of Cadmium

The Zn-depleted synthetic aqueous solution from [0084] mainly contained metals such as Mn (26.1 g), Cd (3.7 g), Ni (3.2 g), Zn (0.2 g) and Co (0.3 g). This solution was prepared according to the metals composition in the raffinate solution from Zn-CYANEX272 solvent extraction at pH 2.5. In accordance with FIG. 6, the pH of this solution was adjusted to 2.9 before being mixed with the organic solvent. The organic solvent consisted of 30 vol. % of D2EHPA®; 5 vol. % of TBP and 65 vol. % of kerosene. Two extraction steps were required to completely extract Cd from the solution and the O/A ratio was fixed at 2/1 (v/v). The temperature was maintained at 50° C. for all of the experiments and the equilibrium pH of 2.9 was controlled by the addition of a solution of NaOH. Cd and Mn were co-extracted and transferred to the organic phase. Using mass balance calculation, approximately 25.8 g of Mn, 3.5 g of Cd, 0.7 g of Ni, 0.2 g of Zn and 0.1 g of Co were transferred to the organic phase. After the separation of organic phase from the aqueous phase, a scrubbing method was used to eliminate the main impurities such as Ni and Co from the organic phase. The scrubbing solution which was concentrated in Mn and Cd allowed the removal of Co and Ni from the organic phase by replacing the impurities molecules present in organic phase by Mn and Cd with pH control. The initial scrubbing solution contained 19.8 g/L of Mn and 12.5 g/L of Cd. The scrubbing O/A ratio was equal to 20/1 (v/v) and its initial pH was fixed at 2.3. The organic solvent collected after the scrubbing step mainly contained Mn and Cd. Approximately 200 mL of scrubbed solution, collected after the first scrubbing stage, was recycled to the extraction step. The Cd and Mn present in the organic solvent were then stripped by the addition of a solution of H₂SO₄ (1.2 M) with the O/A of 4/1 (v/v). After the stripping step, the aqueous solution collected contained Mn (24.2 g), Cd (4.4 g), Ni (0.05 g), Co (0.03 g) and Zn (0.04 g). The reaction time of the extraction steps including the scrubbing step and the stripping step were fixed at 10 minutes for all the tests. The synthetic solution was prepared according to the metal composition in the stripped solution (stripped solution from Cd—Mn-D2EHPA solvent extraction step) then transferred to the electrolysis compartments. Here, the Cd was selectively electrodeposited from the aqueous solution while the other metals (Mn and traces of Ni, Co, Zn) still remained in the aqueous solution. Stainless steel and Ti/IrO₂ were used as the cathode and the anode, respectively. The selective electrowinning of Cd was conducted at pH 2 during 90 minutes with a current density fixed at 360 A/m². The Cd recuperation efficiency by electrowinning was equal to 98% with a loss of manganese estimated at 3.7%. The Cd metallic powder obtained was then washed using distilled water with a solid/liquid ratio (S/L ratio) fixed at 10% in order to eliminate the dissolved manganese. The Cd powder obtained was digested by AQUA REGIA® (HNO₃: HCl=3:1) in order to determine the impurities. Finally, 4.3 g of metallic Cd with a purity of 97% was obtained.

### Recovery of Manganese

After the electrowinning of Cd, the pure aqueous solution of MnSO₄ was further transferred to the precipitation step as revealed in FIG. 6. This effluent contained 23.3 g of Mn. The pH of the solution was adjusted to 7 by the addition of a NaOH solution followed by the addition of 53 g of Na₂CO₃. The Mn present in the pure MnSO₄ aqueous solution was almost all (aver 90%) precipitated at pH 8-9. Filtration was used to separate MnCO₃ precipitate from the liquid (supernatant). The precipitate of MnCO₃ was washed three times by distilled water with a S/L ratio fixed at 10%. A precipitate of MnCO₃ with a 94% purity (23.1 g as Mn) was obtained as a final product.

### Recovery of Nickel

The Zn-, Cd- and Mn-depleted aqueous solution obtained from the D2EHPA® extraction step [0086] contained Mn (0.3 g), Cd (0.2 g), Ni (2.5 g) and Co (0.2 g). This aqueous solution (raffinate) depleted of Zn, Cd and Mn was then transferred to the third solvent extraction step as shown in FIG. 7. The organic solvent consisted of 10 vol. % of CYAN EX® 272, 2 vol. % of TBP and 88 vol. % of kerosene. The pH of the raffinate was initially adjusted to 5.5. The O/A ratio of 0.5/1 (v/v) was applied to selectively extract the impurities (Co, Cd and Mn residues) with an equilibrium pH equal to 5.7. The organic phase was then separated from the aqueous phase. The organic solvent was then stripped with a solution of H₂SO₄ (0.4 M) with O/A ratio of 2/1 (v/v). The temperature and the reaction time were fixed at 50° C. and 10 minutes, respectively.

The washed organic solvents in all solvent extraction steps in this example were reused in the next treatment cycle and the acid solutions emerging from the electrodeposition were returned to the stripping step.

By removing the impurities from the Zn-, Mn- and Cd-depleted aqueous solution using solvent extraction, the aqueous solution rich in Ni (2.3 g as Ni) obtained was transferred to the precipitation compartment. 13 g of Na₂CO₃ were added to precipitate the Ni at pH 7-10. The precipitate of NiCO₃ was then washed two times by distilled water. A S/L ratio fixed at 10% was applied in the washing step and a precipitate of NiCO₃ (2.3 g as Ni) with a purity of 95% was obtained as a final product.

### Example 3

### Recovery of Zinc and Manganese from Alkaline Spent Batteries

The process developed for the recycling of valuable metals from mixed spent batteries can be adapted for the recovery of Zn and Mn from alkaline spent batteries which are considered as the majority of commercial battery products. The recycling process used for alkaline spent batteries consists of: a) crushing and grinding; b) screening to obtain the fine particles; c) acid extracting; d) selectively recovering Zn by electrowinning; e) removing residual Zn by precipitation using NaOH and Na₂S; e) solid-liquid separation; g) recovering Mn by precipitation in a carbonate form using Na₂CO₃.

The present example is adapted to treat spent alkaline batteries. The recycling of Zn and Mn from alkaline spent batteries process comprises the steps of:
Crushing and grinding the alkaline spent batteries.
Screening to retain the coarse particles and grinding the fine particles to obtain a fine powder.
Acid extraction with H₂SO₄ and addition of a stoichiometry amount of a reducing agent to reduce Mn(IV) to Mn(II) and to improve the solubilization of Mn.
Solid-liquid separation by filtration.
Treating the leachate (ZnSO₄ and MnSO₄ solution) by electrowinning. During this step, Zn is selectively electrodeposited with a purity of 98%.
Treating the Zn that is still present in the solution by precipitation with NaOH and Na₂S at pH 4.5. In this step, some amount of Mn is co-precipitated with Zn. This precipitate is recycled back to the leaching step.
Precipitation of the Mn from the sulfate solution with Na₂CO₃ at pH 8-9. A precipitate of MnCO₃ (purity of 98%) is obtained as a final product.

The alkaline spent batteries recycling process in this example is revealed in FIG. 8. Crushing, screening and grinding methods are applied in order to obtain a fine alkaline batteries powder. Approximately 109 g of homogenized powder was mixed with 1 L of a solution of H₂SO₄ (1.34 M) during 45 minutes at ambient temperature.

At the beginning of the leaching step, 49 g of sodium metabisulfite (Na₂S₂O₅) were added to the leaching solution to reduce Mn(IV) to Mn(II). After the solid-liquid separation, the leaching solution mainly contained of 23.1 g of Mn, 17.3 g of Zn and 0.23 g of Fe. The Zn was selectively electrodeposited from the leachate at pH 2 using stainless steel as cathode and Ti/IrO₂ as anode. The current density was fixed at 270 A/m². Three steps of electrowinning were conducted in order to recover the quantity maximum of metallic zinc without any pH control. The reaction time of each electrowinning step was equal to 90 minutes. Only a small quantity of Fe was co-deposited with Zn, so it was negligible in this example. If Fe is present in high concentration, it can be eliminated by precipitation at pH 4 in the presence of an oxidizing agent H₂O₂ to oxidize Fe(II) to Fe(III) and improve the precipitation of iron as ferric hydroxide (Fe(OH)₃). The deposit of Zn was then washed with distilled water to eliminate the soluble manganese. The cathode was washed with 5% HNO₃ in order to determine the impurities present in the deposit of metallic zinc. Approximately 13.8 g of metallic zinc with a purity of 98% was obtained as a final product. Manganese was supposed to be oxidized to MnO₂ at the anode. The quantity of manganese recuperated was estimated at 4.3 g and this deposit could be reused as the primary source.

The effluent emerging from the electrowinning (Zn-depleted solution) mainly contained Zn (3.5 g), Mn (18.8 g) and Fe (0.23 g). The Zn remaining in the leachate was removed by precipitation in order to obtain a pure MnSO₄ solution. A solution of NaOH was used to adjust the pH to 4 followed by the addition of 15.7 g of Na₂S. With this precipitation step, 99% of Zn was precipitated at pH 4.5 from 1 L of the leachate emerging from the electrowinning. The Mn co-precipitated with Zn during this precipitation step and 17% of Mn was lost. Then, Mn was recovered as the carbonate form by precipitation using Na₂CO₃. The precipitation step consisted of the adjustment of the pH to 7 by addition of a solution of NaOH followed by the addition of 32.7 g of Na₂CO₃. Mn was precipitated at pH between 8 and 9. A precipitate of MnCO₃ was then washed three times with distilled water (10% S/L ratio). After the washing steps, only 0.4% of the Mn initially present in the precipitate was lost and a precipitate of MnCO₃ (15.7 g as Mn) with a purity of 98% was obtained as a final product.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

All patents, patent applications and publications mentioned in this specification are herein incorporated by reference to the same extent as if each independent patent, patent application or publication was specifically and individually indicated to be incorporated by reference.

### REFERENCES

RIS international Ltd., 2007. Canadian Consumer Battery Baseline Study. Available at the following address: www.docstoc.com/docs/79783916/Canadian-Consumer-Battery-Baseline-Study-Final-Report. Consulted on 27 Jul. 2015.
Call2Recycle, 2012. Quebec takes environmental preservation to next level with battery recycling. Available at the following address: www.call2recycle.ca/quebec-takes-environmental-preservation-to-next-level-with-battery-recycling/. Consulted on 26 Jul. 2015.

1. A process for recovering valuable metals from spent batteries comprising the steps of:
a) crushing the spent batteries;
b) separating debris as a coarse fraction and a fine fraction;
c) leaching metals present in the fine fraction with strong inorganic acid and a reducing agent to produce an aqueous leachate;
d) extracting Zn from the leachate by electrowinning to obtain a metallic deposit of Zn and a Zn-depleted aqueous solution; and
e) extracting Mn from the Zn-depleted aqueous solution of d) by precipitation at pH of about 8-9 to obtain precipitated Mn and a Zn- and Mn-depleted aqueous solution.

2. The process of claim 1, wherein in the leaching step c), the strong inorganic acid is selected from the group consisting of: sulfuric acid (H₂SO₄), hydrochloric acid (HCl) and nitric acid (HNO₃).

3. The process of claim 1, wherein the reducing agent in step c) is sodium meta bisulfite or gaseous SO₂, which reduces Mn(IV) to Mn(II).

4. The process of claim 1, wherein the electrowinning in step d) is carried out at about pH 2.

5. The process of claim 1, further comprising a step:
d-i) eliminating residual Zn by precipitation as ZnS using NaOH and Na₂S to obtain a rich MnSO₄ solution.

6. The process of claim 5, wherein elimination of residual Zn in step d-i) is carried out by selective precipitation at pH of about 4.5.

7. The process of claim 5, further comprising eliminating impurities remaining following step d-i), by using an organic phase composed of CYANEX® 272 at pH of about 2.5, at a temperature of about 40° C. to about 60° C.

8. The process of claim 1, wherein the recovery of Mn as MnCO₃ in step e) is carried out at pH of about 8-9.

9. The process of claim 1, wherein the spent batteries are alkaline batteries, and said step d) is carried out at a temperature of about 20° C.

10. The process of claim 1, wherein the spent batteries belong to a mixture of different types of spent batteries, and said step d) is carried out at a temperature of about 50° C.

11. The process of claim 10, wherein the batteries are selected from the group consisting of: alkaline (Zn/MnO₂); Zn-carbon; Ni—Cd; Ni—MH; Li ion; Li M; and mixtures thereof.

12. The process of claim 10, wherein the crushing step a) is carried out at low temperature at least under −20° C.

13. The process of claim 10, further comprising step d-ii) extracting Zn from the leachate by aqueous solvent extraction.

14. The process of claim 13, wherein the extraction of Zn in step d-ii) is carried out using an organic phase comprising CYANEX® 272 at pH of about 2.5, at a temperature of about 40° C. to about 60° C.

15. The process of claim 14, wherein the Zn is stripped from the organic phase by the addition of H₂SO₄ at a ratio organic:aqueous phases of 2:1 (v/v).

16. The process of claim 10, wherein step e) further comprises extracting Mn from the Zn-depleted aqueous solution of step d) by aqueous solvent extraction.

17. The process of claim 10, further comprising a step:
d-iii) extracting Cd from the Zn-depleted aqueous solution of d) by organic solvent extraction and electrodeposition to obtain a Zn-, Cd- and Mn-depleted solution.

18. The process of claim 10, wherein the extractions of Cd and Mn in steps d-iii) and e) are carried out simultaneously using an organic phase composed of DEHPA® at pH of about 2.5.

19. The process of claim 10, further comprising steps:
f) eliminating impurities from the Zn-, Cd- and Mn-depleted aqueous solution at pH about 5-6 to obtain a purified solution of NiSO₄; and
g) precipitating Ni from the NiSO₄ solution.

20. A process for recovering metals from alkaline spent batteries comprising the steps of:
a) crushing to obtain a coarse fraction and a fine fraction rich in Zn and Mn;
b) carrying out leaching on the fine particles in presence of sulfuric acid and a reducing agent to reduce Mn(IV) to Mn(II);
c) selectively recovering Zn by electrowinning;
d) eliminating residual Zn by precipitation as ZnS using NaOH and Na₂S to obtain a rich MnSO₄ solution; and
e) precipitating the Mn in carbonate form from the MnSO₄-rich solution.

21. A process for recovering valuable metals from a mixture of spent batteries comprising the steps of:
a) crushing the spent batteries at a temperature at least as low as −20° C.;
b) separating debris as a coarse fraction and a fine fraction by passing the debris through a screen or a sieve;
c) leaching metals present in the fine fraction with a strong inorganic acid and a reducing agent to produce an aqueous leachate;
d) extracting Zn from the leachate by solvent extraction and electrodeposition to obtain a metallic deposit of Zn and a Zn-depleted aqueous solution;
e) extracting Cd from the Zn-depleted aqueous solution by solvent extraction and electrodeposition;
f) extracting Mn from the Zn-depleted aqueous solution of d) by organic solvent extraction and precipitation to obtain a Zn-, Cd- and Mn-depleted aqueous solution;
g) eliminating impurities from the Zn-, Cd- and Mn-depleted aqueous solution by organic solvent extraction to obtain a purified solution of NiSO₄; and
h) precipitating Ni from the NiSO₄ solution.
